(19) United States
(12) Patent Application Publication
(10) Pub. No.: US 2024/0053377 A1
(43) Pub. Date: Feb. 15, 2024

(54) ACCELERATION SENSOR

(71) Applicant: ROHM CO., LTD., Kyoto (JP)

(72) Inventor: Martin Wilfried HELLER, Kyoto (JP)

(73) Assignee: ROHM CO., LTD., Kyoto (JP)

(21) Appl. No.: 18/365,630

(22) Filed: Aug. 4, 2023

(30) Foreign Application Priority Data
Aug. 15, 2022 (JP) 2022-129238

(51) Int. Cl. G01P 15/125

(52) U.S. Cl. CPC G01P 15/125

(57) ABSTRACT

An acceleration sensor includes a first substrate and a second substrate, wherein the first substrate includes: a first anchor region provided on a partial region of a bottom surface of a first substrate cavity; a first anchor protruding from the first anchor region toward the second substrate along a first direction; a spring extending from the first anchor in a second direction perpendicular to the first direction; and a movable electrode mechanically connected to and electrically insulated from the spring, and configured to be displaced in the first direction, and wherein the second substrate includes: a second anchor region provided on a partial region of a bottom surface of a second substrate cavity; a second anchor protruding from the second anchor region toward the first substrate along the first direction; and a fixed electrode mechanically fixed to the second anchor and facing the movable electrode.

### CROSS-REFERENCE TO RELATED APPLICATION

This application is based upon and claims the benefit of priority from Japanese Patent Application No. 2022-129238, filed on Aug. 15, 2022, the entire contents of which are incorporated herein by reference.

### TECHNICAL FIELD

The present disclosure relates to an acceleration sensor.

### BACKGROUND

An acceleration sensor that includes a first semiconductor substrate and a second semiconductor substrate vertically facing each other is known. The second semiconductor substrate has a weight portion supported by a cantilever that moves slightly in a vertical direction when acceleration in the vertical direction is generated. The first semiconductor substrate has an electrode facing the weight portion. The acceleration sensor is a capacitive acceleration sensor that detects a change in electrostatic capacitance between the weight portion and the electrode when vertical acceleration is generated, and calculates the acceleration.

### BRIEF DESCRIPTION OF DRAWINGS

The accompanying drawings, which are incorporated in and constitute a part of the specification, illustrate embodiments of the present disclosure.

FIG. 1 is a cross-sectional view of an acceleration sensor according to an embodiment of the present disclosure.

FIG. 2 is a plan view of a first substrate of the acceleration sensor of FIG. 1.

FIG. 3 is a plan view of a second substrate of the acceleration sensor of FIG. 1.

FIG. 4 is a circuit diagram of the acceleration sensor of FIG. 1.

FIG. 5 is a partially-enlarged view of an acceleration sensor according to another embodiment.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Embodiments of the present disclosure will be described below with reference to the accompanying drawings. It should be noted that the following description is essentially and merely an example and is not intended to limit the present disclosure, its applications, or its uses. Moreover, the drawings are schematic, and a ratio or the like of each dimension is different from an actual one.

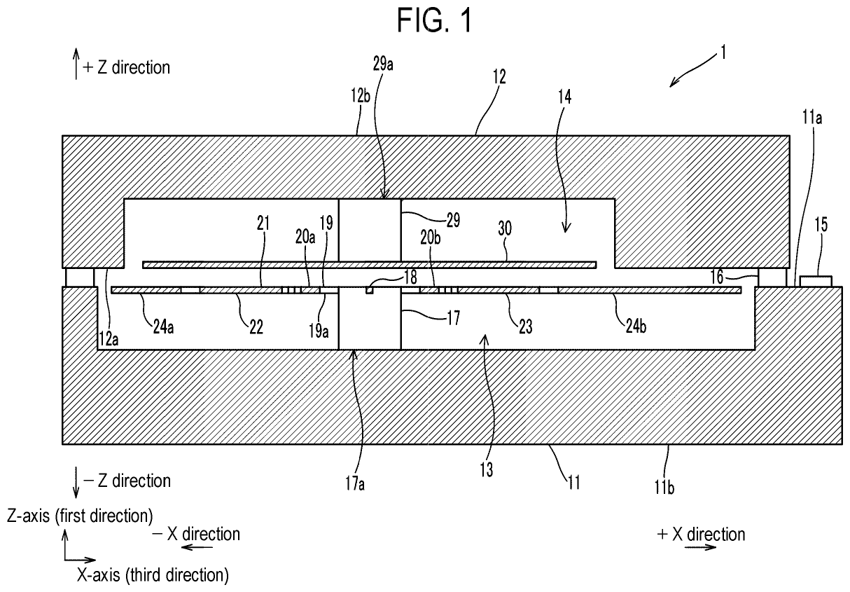

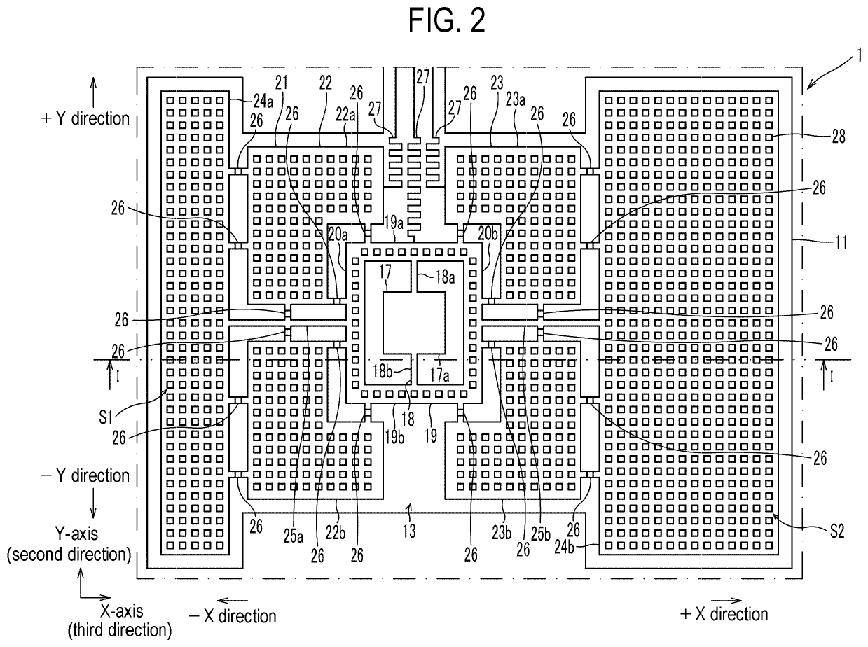

FIG. 1 is a cross-sectional view of an acceleration sensor 1 according to an embodiment of the present disclosure, and is a cross-sectional view taken along two-dot chain line I in FIG. 2 to be described later. The acceleration sensor 1 includes a first substrate 11 and a second substrate 12 facing each other in a first direction. In the present embodiment, the first direction is a vertical direction in FIG. 1, that is, a height direction of the acceleration sensor 1, and is called a Z-axis direction. An upper direction of the acceleration sensor 1 is called a +Z direction, and a lower direction thereof is called a —Z direction.

The first substrate 11 is arranged in the —Z direction from the second substrate 12. The first substrate 11 has a first substrate first main surface 11a and a first substrate second main surface 11b facing each other in the Z-axis direction. The first substrate first main surface 11a is located in the +Z direction from the first substrate second main surface 11b. The first substrate 11 has a first substrate cavity 13 recessed from the first substrate first main surface 11a toward the first substrate second main surface 11b, that is, in the —Z direction.

The second substrate 12 has a second substrate first main surface 12a and a second substrate second main surface 12b facing each other in the Z-axis direction. The second substrate first main surface 12a is located in the —Z direction from the second substrate second main surface 12b. The second substrate first main surface 12a faces the first substrate first main surface 11a from the +Z direction. The second substrate 12 has a second substrate cavity 14 recessed from the second substrate first main surface 12a toward the second substrate second main surface 12b, that is, in the +Z direction.

In the present embodiment, the first substrate 11 is a base substrate made of silicon, while the second substrate 12 is a lid substrate made of silicon. The first substrate 11 has an electrode pad 15 that is provided on the first substrate first main surface 11a and electrically connected to an electric circuit provided on the first substrate 11 and the second substrate 12, which will be described later, for inputting and outputting an electric signal.

The first substrate 11 and the second substrate 12 are fixed together via a fixing layer 16 at a location outside the first substrate cavity 13 and the second substrate cavity 14, respectively. By fixing the first substrate 11 and the second substrate 12 together, the first substrate cavity 13 and the second substrate cavity 14 are sealed.

### [First Substrate]

The first substrate 11 has a first anchor region 17a provided in a partial region of a bottom surface of the first substrate cavity 13, and a first anchor 17 protruding from the first anchor region 17a toward the second substrate first main surface 12a, that is, in the +Z direction.

FIG. 2 is a plan view of the first substrate 11 of FIG. 1 when viewed from the +Z direction. The first anchor region 17a has a square shape when viewed from the +Z direction, and has a length of 10 μm or more and 40 μm or less in a second direction and a third direction that are perpendicular to the Z-axis direction. In the present embodiment, the second direction is the vertical direction in FIG. 2, that is, the vertical direction of the acceleration sensor 1, and is called a Y-axis direction. The third direction is a horizontal direction in FIG. 2, that is, the horizontal direction of the acceleration sensor 1, and is called an X-axis direction. In FIG. 2, an upper direction is called a +Y direction, a lower direction is called a −Y direction, a right-hand side is called a +X direction, and a left-hand side is called a −X direction.

The first substrate 11 has a spring 18 extending in both sides of the Y-axis direction from an end portion of the first anchor 17 facing the +Z direction. In the embodiment, the spring 18 includes a beam-shaped first spring 18a extending from the first anchor 17 in the +Y direction and a second beam-shaped spring 18b extending from the first anchor 17 in the −Y direction. The first spring 18a and the second spring 18b are supported by the first anchor 17 and float in the +Z direction with respect to the bottom surface of the first substrate cavity 13.

In the present embodiment, a first main frame 19a extending in both sides of the X-axis direction is connected to an end portion of the first spring 18a facing the +Y direction. A second main frame 19b extending in both sides of the X-axis direction is connected to an end portion of the second spring 18b facing the −Y direction. The first main frame 19a and the second main frame 19b are supported by the first anchor 17 and float in the +Z direction with respect to the bottom surface of the first substrate cavity 13. In the present embodiment, the first main frame 19a and the second main frame 19b are collectively referred to as a main frame 19.

A first sub-frame 20a extending in the Y-axis direction is connected to an end portion of the first main frame 19a facing the −X direction and an end portion of the second main frame 19b facing the −X direction. A second sub-frame 20b extending in the Y-axis direction is connected to an end portion of the first main frame 19a facing the +X direction and an end portion of the second main frame 19b facing the +X direction. The first sub-frame 20a and the second sub-frame 20b are supported by the first anchor 17 and float in the +Z direction with respect to the bottom surface of the first substrate cavity 13.

The first substrate 11 has a movable electrode 21 that is mechanically connected to and electrically insulated from the first main frame 19a, the second main frame 19b, the first sub-frame 20a, and the second sub-frame 20b. The movable electrode 21 includes a first movable electrode 22 that is arranged on a −X direction side of the first anchor 17 to surround the first main frame 19a, the second main frame 19b, and the first sub-frame 20a with the first anchor 17, and a second movable electrode 23 that is arranged on a +X direction side of the first anchor 17 to surround the first main frame 19a, the second main frame 19b, and the second sub-frame 20b with the first anchor 17.

In the present embodiment, the first movable electrode 22 has a first movable electrode first portion 22a that is arranged on the +Y direction side and is mechanically connected to and electrically insulated from the first main frame 19a and the first sub-frame 20a, and a first movable electrode second portion 22b that is spaced apart from the first movable electrode first portion 22a in the −Y direction and is mechanically connected to and electrically insulated from the second main frame 19b and the first sub-frame 20a. The first movable electrode first portion 22a and the first movable electrode second portion 22b are supported by the first anchor 17 and float in the +Z direction with respect to the bottom surface of the first substrate cavity 13.

The second movable electrode 23 has a second movable electrode first portion 23a that is arranged on the +Y direction side and is mechanically connected to and electrically insulated from the first main frame 19a and the second sub-frame 20b, and a second movable electrode second portion 23b that is spaced apart from the second movable electrode first portion 23a in the −Y direction and is mechanically connected to and electrically insulated from the second main frame 19b and the second sub-frame 20b. The second movable electrode first portion 23a and the second movable electrode second portion 23b are supported by the first anchor 17 and float in the +Z direction with respect to the bottom surface of the first substrate cavity 13.

The first substrate 11 has a first mass 24a that is mechanically connected to and electrically insulated from the first movable electrode 22, and a second mass 24b that is mechanically connected to and electrically insulated from the second movable electrode 23 and has a larger mass than the first mass 24a. The first mass 24a and the second mass 24b are supported by the first anchor 17 and float in the +Z direction with respect to the bottom surface of the first substrate cavity 13.

In the present embodiment, the first mass 24a is arranged on the −X direction side of the first movable electrode 22, has a rectangular shape extending in the X and Y directions, and is mechanically connected to and electrically insulated from end portions of the first movable electrode first portion 22a and the first movable electrode second portion 22b that face the —X direction.

The second mass 24b is arranged on the +X direction side of the second movable electrode 23, has a rectangular shape extending in the X and Y directions, and is mechanically connected to and electrically insulated from end portions of the second movable electrode first portion 23a and the second movable electrode second portion 23b that face the +X direction.

When viewed from the +Z direction, the first mass 24a has a first surface area S1 with respect to an XY plane. On the other hand, the second mass 24b has a second surface area S2 larger than the first surface area S1 with respect to the XY plane.

The first substrate 11 has a first reinforcing frame 25a that is located between the first movable electrode first portion 22a and the first movable electrode second portion 22b and extends in the −X direction from the first sub-frame 20a toward the first mass 24a, and a second reinforcing frame 25b that is located between the second movable electrode first portion 23a and the second movable electrode second portion 23b and extends in the +X direction from the second sub-frame 20b toward the second mass 24b. The first reinforcing frame 25a and the second reinforcing frame 25b are supported by the first anchor 17 and float in the +Z direction with respect to the bottom surface of the first substrate cavity 13.

The first reinforcing frame 25a is mechanically connected to the first sub-frame 20a and the first mass 24a and is mechanically connected to and electrically insulated from an end portion of the first movable electrode first portion 22a facing the −Y direction and an end portion of the first movable electrode second portion 22b facing the +Y direction.

The second reinforcing frame 25b is mechanically connected to the second sub-frame 20b and the second mass 24b and is mechanically connected to and electrically insulated from an end portion of the second movable electrode first portion 23a facing the −Y direction and an end portion of the second movable electrode second portion 23b facing the +Y direction.

The first movable electrode first portion 22a, the first movable electrode second portion 22b, the second movable electrode first portion 23a, and the second movable electrode second portion 23b are mechanically connected to and electrically insulated from the first main frame 19a, the second main frame 19b, the first sub-frame 20a, the second sub-frame 20b, the first mass 24a, the second mass 24b, the first reinforcing frame 25a, and the second reinforcing frame 25b via isolation joints 26, respectively.

Each isolation joint 26 is silicon oxide formed by, for example, forming a trench in the first substrate first main surface 11a and thermally oxidizing a conductive silicon on both walls of the trench, and both sides of the isolation joint 26 are mechanically connected to and electrically insulated from each other. The isolation joints 26 are supported by the first anchor 17 and float in the +Z direction with respect to the bottom surface of the first substrate cavity 13.

The isolation joint 26 is provided between the first movable electrode first portion 22a and the first main frame 19a. The first movable electrode first portion 22a and the first main frame 19a are mechanically connected to and electrically insulated from each other in the Y-axis direction via the isolation joint 26.

The isolation joint 26 is provided between the first movable electrode first portion 22a and the first sub-frame 20a. The first movable electrode first portion 22a and the first sub-frame 20a are mechanically connected to and electrically insulated from each other in the X-axis direction via the isolation joint 26.

The isolation joint 26 is provided between the first movable electrode second portion 22b and the second main frame 19b. The first movable electrode second portion 22b and the second main frame 19b are mechanically connected to and electrically insulated from each other in the Y-axis direction via the isolation joint 26.

The isolation joint 26 is provided between the first movable electrode second portion 22b and the first sub-frame 20a. The first movable electrode second portion 22b and the first sub-frame 20a are mechanically connected to and electrically insulated from each other in the X-axis direction via the isolation joint 26.

The isolation joint 26 is provided between the second movable electrode first portion 23a and the first main frame 19a. The second movable electrode first portion 23a and the first main frame 19a are mechanically connected to and electrically insulated from each other in the Y-axis direction via the isolation joint 26.

The isolation joint 26 is provided between the second movable electrode first portion 23a and the second sub-frame 20b. The second movable electrode first portion 23a and the second sub-frame 20b are mechanically connected to and electrically insulated from each other in the X-axis direction via the isolation joint 26.

The isolation joint 26 is provided between the second movable electrode second portion 23b and the second main frame 19b. The second movable electrode second portion 23b and the second main frame 19b are mechanically connected to and electrically insulated from each other in the Y-axis direction via the isolation joint 26.

The isolation joint 26 is provided between the second movable electrode second portion 23b and the second sub-frame 20b. The second movable electrode second portion 23b and the second sub-frame 20b are mechanically connected to and electrically insulated from each other in the X-axis direction via the isolation joint 26.

Two isolation joints 26 arranged in the Y-axis direction are provided between the first movable electrode first portion 22a and the first mass 24a. The first movable electrode first portion 22a and the first mass 24a are mechanically connected to and electrically insulated from each other in the X-axis direction via the two isolation joints 26.

Two isolation joints 26 arranged in the Y-axis direction are provided between the first movable electrode second portion 22b and the first mass 24a. The second movable electrode first portion 22b and the first mass 24a are mechanically connected to and electrically insulated from each other in the X-axis direction via the two isolation joints 26.

Two isolation joints 26 arranged in the Y-axis direction are provided between the second movable electrode first portion 23a and the second mass 24b. The second movable electrode first portion 23a and the second mass 24b are mechanically connected to and electrically insulated from each other in the X-axis direction via the two isolation joints 26.

Two isolation joints 26 arranged in the Y-axis direction are provided between the second movable electrode second portion 23b and the second mass 24b. The second movable electrode second portion 23b and the second mass 24b are mechanically connected to and electrically insulated from each other in the X-axis direction via the two isolation joints 26.

The isolation joint 26 is provided between the first movable electrode first portion 22a and the first reinforcing frame 25a. The first movable electrode first portion 22a and the first reinforcing frame 25a are mechanically connected to and electrically insulated from each other in the Y-axis direction via the isolation joint 26.

The isolation joint 26 is provided between the first movable electrode second portion 22b and the first reinforcing frame 25a. The first movable electrode second portion 22b and the first reinforcing frame 25a are mechanically connected to and electrically insulated from each other in the Y-axis direction via the isolation joint 26.

The isolation joint 26 is provided between the second movable electrode first portion 23a and the second reinforcing frame 25b. The second movable electrode first portion 23a and the second reinforcing frame 25b are mechanically connected to and electrically insulated from each other in the Y-axis direction via the isolation joint 26.

The isolation joint 26 is provided between the second movable electrode second portion 23b and the second reinforcing frame 25b. The second movable electrode second portion 23b and the second reinforcing frame 25b are mechanically connected to and electrically insulated from each other in the Y-axis direction via the isolation joint 26.

In the present embodiment, a flex lead 27 is attached to each of an end portion of the first main frame 19a facing the +Y direction, an end portion of the first movable electrode first portion 22a facing the +X direction, and an end portion of the second movable electrode first portion 23a facing the −X direction. The flex leads 27 are supported by the first anchor 17 and float with respect to the bottom surface of the first substrate cavity 13. The flex leads 27 are connected to the electrode pad 15 via a wiring layer (not shown).

The first movable electrode first portion 22a and the first movable electrode second portion 22b are electrically connected to each other via a wiring layer (not shown). The second movable electrode first portion 23a and the second movable electrode second portion 23b are electrically connected to each other via a wiring layer (not shown).

In the present embodiment, each of the first main frame 19a, the second main frame 19b, the first sub-frame 20a, the second sub-frame 20b, the first movable electrode first portion 22a, the first movable electrode second portion 22b, the second movable electrode first portion 23a, the second movable electrode second portion 23b, the first mass 24a, the second mass 24b, the first reinforcing frame 25a, and the second reinforcing frame 25b has a plurality of holes 28.

Bottoms of the plurality of holes 28 are connected to one another by isotropic etching to form the first substrate cavity 13. Therefore, the first main frame 19a, the second main frame 19b, the first sub-frame 20a, the second sub-frame 20b, the first movable electrode first portion 22a, the first movable electrode second portion 22b, the second movable electrode first portion 23a, the second movable electrode second portion 23b, the first mass 24a, and the second mass 24b are supported by the first anchor 17 and float in the +Z direction with respect to the bottom surface of the first substrate cavity 13.

### [Second Substrate]

As shown in FIG. 1, the second substrate 12 has a second anchor region 29a provided in a partial region of a bottom surface of the second substrate cavity 14, and a second anchor 29 protruding from the second anchor region 29a toward the first substrate first main surface 11a, that is, in the —Z direction. The first anchor region 17a and the second anchor region 29a face each other in the Z-axis direction. The first anchor 17 and the second anchor 29 face each other in the Z-axis direction.

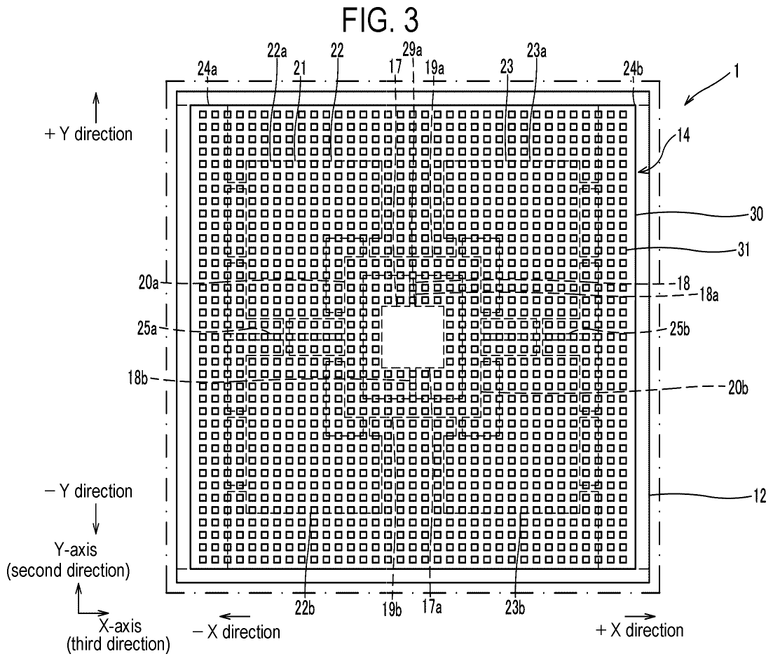

FIG. 3 is a plan view of the second substrate 12 of FIG. 1 when viewed from the —Z direction. The second anchor region 29a has a square shape when viewed from the −Z direction, and has a length of 10 μm or more and 40 μm or less in the second direction and the third direction that are perpendicular to the Z-axis direction. In the present embodiment, the first anchor region 17a and the second anchor region 29a have the same surface area.

The second substrate 12 has a fixed electrode 30, which extends in the X and Y directions from an end portion of the second anchor 29 facing the —Z direction and faces the movable electrode 21. In the present embodiment, the fixed electrode 30 has a square shape when viewed from the —Z direction, and has a size that overlaps with the first movable electrode first portion 22a, the first movable electrode second portion 22b, the second movable electrode first portion 23a, and the second movable electrode second portion 23b.

In the present embodiment, the fixed electrode 30 has a plurality of holes 31.

The holes 31 are connected to one another by isotropic etching to form the second substrate cavity 14. Therefore, the fixed electrodes 30 are supported by the second anchor 29 and float in the —Z direction with respect to the bottom surface of the second substrate cavity 14.

### [Operations of Acceleration Sensor]

When acceleration in the Z-axis direction is generated, the second mass 24b, which has a larger mass than the first mass 24a, tries to remain due to inertia, while the first mass 24a, which has a smaller mass than the second mass 24b, tends to swing in the Z-axis direction. As a result, the first movable electrode 22 mechanically connected to the first mass 24a is displaced largely in the Z-axis direction with respect to the second movable electrode 23 mechanically connected to the second mass 24b. In addition, since the first movable electrode 22 and the second movable electrode 23 are mechanically connected to both sides of the spring 18 in the X-axis direction via the main frame 19, when the acceleration in the Z-axis direction is generated, the spring 18 is twisted around the Y-axis direction. Thus, when the acceleration in the Z-axis direction is generated, the first movable electrode 22 and the second movable electrode 23 are displaced in opposite directions in the Z-axis direction, like a seesaw. Therefore, a difference in displacement in the Z-axis direction is likely to be generated between the first movable electrode 22 and the second movable electrode 23.

The acceleration sensor 1 detects a change in first electrostatic capacitance C1 between the first movable electrode 22 and the fixed electrode 30 and a change in second electrostatic capacitance C2 between the second movable electrode 23 and the fixed electrode 30, and calculates a direction of acceleration and a value of the acceleration.

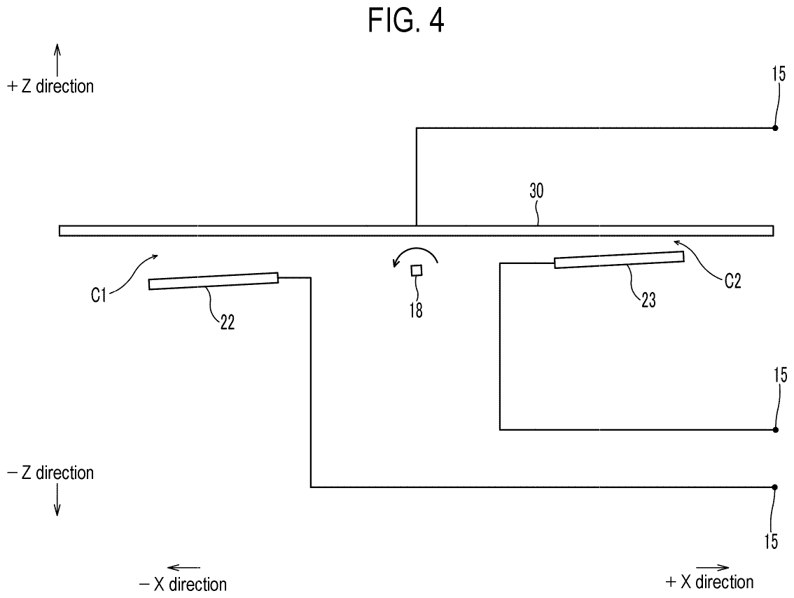

FIG. 4 is a circuit diagram of the acceleration sensor 1 of FIG. 1 and shows a situation when acceleration in the —Z direction is generated. When the acceleration in the —Z direction is generated, the first movable electrode 22 swings in the —Z direction and the spring 18 twists counterclockwise in FIG. 4. Therefore, since the second movable electrode 23 swings in the +Z direction opposite to the first movable electrode 22, a difference in displacement is generated between the first movable electrode 22 and the second movable electrode 23. Since a distance between the first movable electrode 22 and the fixed electrode 30 increases and a distance between the second movable electrode 23 and the fixed electrode 30 decreases, the first electrostatic capacitance C1 decreases and the second electrostatic capacitance C2 increases.

Each of the first movable electrode 22, the second movable electrode 23, and the fixed electrode 30 is electrically connected to a plurality of different electrode pads 15 via the flex leads 27.

When a driving voltage is connected to the first movable electrode 22 and the second movable electrode 23 via the electrode pads 15, the first electrostatic capacitance C1 between the first movable electrode 22 and the fixed electrode 30 and the second electrostatic capacitance C2 between the second movable electrode 23 and the fixed electrode 30 are synthesized, and a change in the synthesized electrostatic capacitance is detected from the electrode pad 15 connected to the fixed electrode 30. Thus, acceleration is calculated, and a direction of the acceleration is determined.

When the driving voltage is connected to an extraction electrode 32 via the electrode pad 15, the first electrostatic capacitance C1 between the first movable electrode 22 and the fixed electrode 30 and the second electrostatic capacitance C2 between the second movable electrode 23 and the fixed electrode 30 are detected from the electrode pads 15 connected to extraction electrodes 27a and 27b, respectively, acceleration is calculated based on the two electrostatic capacitances C1 and C2, and a direction of the acceleration is determined.

The acceleration sensor 1 according to the above embodiment exhibits the following effects.

The acceleration sensor 1 of the present disclosure includes the movable electrode 21 operably supported by the first anchor 17 of the first substrate 11 via the spring 18, and the fixed electrode 30 mechanically fixed to the second anchor 29 of the second substrate 12. Thus, since the movable electrode 21 and the fixed electrode 30 are arranged on the first substrate 11 and the second substrate 12 via the first anchor 17 and the second anchor 29, respectively, even when the first substrate 11 and the second substrate 12 are deformed due to a package stress, external force during packaging, or heat, the movable electrode 21 and the fixed electrode 30 are not easily affected by the deformation. Therefore, when acceleration in the Z-axis direction is generated, the acceleration sensor 1 can detect a change in electrostatic capacitance between the movable electrode 21 and the fixed electrode 30 and calculate the acceleration in the Z-axis direction, while suppressing an influence of the package stress, external force during packaging, or heat.

In addition, even when the first substrate 11 and the second substrate 12 are deformed during packaging, since the movable electrode 21 and the fixed electrode 30 are not easily affected by the deformation of the first substrate 11 and the second substrate 12, there is little need to calibrate the sensor.

The acceleration sensor 1 includes the first substrate 11 as a base substrate, and the second substrate 12 as a lid substrate that seals the first substrate cavity 13 and the second substrate cavity 14 together with the first substrate 11. Therefore, the movable electrode 21 and the fixed electrode 30 are sealed in a space formed by the first substrate cavity 13 and the second substrate cavity 14.

The fixed electrode 30 has a size that overlaps with the movable electrode 21. Thus, the entire surface of the movable electrode 21 is charged. Therefore, even when an assembly position of the first substrate 11 and the second substrate 12 deviates, the acceleration sensor 1 can detect a change in electrostatic capacitance of the entire surface of the movable electrode 21 when acceleration in the Z-axis direction is generated. Accordingly, the acceleration in the Z-axis direction can be calculated accurately.

The movable electrode 21 has the first movable electrode 22 and the second movable electrode 23. Thus, the acceleration sensor 1 can detect a change in the first electrostatic capacitance C1 between the first movable electrode 22 and the fixed electrode 30 and a change in the second electrostatic capacitance C2 between the second movable electrode 23 and the fixed electrode 30, and calculate the acceleration in the Z-axis direction.

The first mass 24a is mechanically connected to the first movable electrode 22, and the second mass 24b having a larger mass than the first mass 24a is mechanically connected to the second movable electrode 23. Thus, when the acceleration in the Z-axis direction is generated, a difference in displacement in the Z-axis direction is generated due to inertia between the first movable electrode 22 and the second movable electrode 23. Therefore, the movable electrode 21 tilts to either side of the Z-axis direction. Accordingly, the acceleration sensor 1 can determine a direction of the acceleration from the tilt of the movable electrode 21 when the acceleration in the Z-axis direction is generated.

Since the second mass 24b is larger than the first mass 24a, the second mass 24b has a larger mass than the first mass 24a.

Each of the first movable electrode 22 and the second movable electrode 23 is mechanically connected to and electrically insulated from the spring 18 via the main frame 19. Therefore, rigidity between the movable electrode 21 and the spring 18 is ensured, and the movable electrode 21 is securely attached to the spring 18.

The main frame has the first main frame 19a mechanically connected to the first spring 18a extending in one side of the Y-axis direction, and the second main frame 19b mechanically connected to the second spring 18b extending in the other side of the Y-axis direction. Thus, each of the first movable electrode 22 and the second movable electrode 23 has a shape, which is mechanically connected to the first main frame 19a and the second main frame 19b and extends in the Y-axis direction. Therefore, since the movable electrode 21 has a large region, the electrostatic capacitance thereof is large.

The first sub-frame 20a and the second sub-frame 20b are mechanically connected to the first main frame 19a and the second main frame 19b. Thus, rigidity of the first main frame 19a and the second main frame 19b is secured. Therefore, the first movable electrode 22 and the second movable electrode 23 mechanically connected to the first main frame 19a and the second main frame 19b are securely attached to the first spring 18a and the second spring 18b, respectively.

The first movable electrode 22 has the first movable electrode first portion 22a and the first movable electrode second portion 22b spaced apart from the first movable electrode first portion 22a. In addition, the second movable electrode 23 has the second movable electrode first portion 23a and the second movable electrode second portion 23b spaced apart from the second movable electrode first portion 23a.

The first mass 24a and the second mass 24b are respectively supported by the first sub-frame 20a and the second sub-frame 20b that are mechanically connected to the first main frame 19a and the second main frame 19b via the first reinforcing frame 25a and the second reinforcing frame 25b. Therefore, the first mass 24a and the second mass 24b are supported by the first main frame 19a and the second main frame 19b, respectively, without being deformed.

The movable electrode 21 has a potential different from that of the fixed electrode 30 by being electrically insulated from the first main frame 19a, the second main frame 19b, the first sub-frame 20a, the second sub-frame 20b, the first mass 24a, the second mass 24b, the first reinforcing frame 25a, and the second reinforcing frame 25b by the isolation joints 26. Therefore, when the acceleration in the Z-axis direction is generated, the acceleration sensor 1 can detect a change in electrostatic capacitance between the movable electrode 21 and the fixed electrode 30 and calculate the acceleration in the Z-axis direction.

The first anchor region 17a and the second anchor region 29a have the length of 10 μm or more and 40 μm or less in the X-axis direction and the Y-axis direction, respectively. Thus, since the first anchor 17 and the second anchor 29 are small, when the first substrate 11 and the second substrate 12 are deformed by an external force or heat, it is difficult to transfer the influence of the deformation to the movable electrode 21. Therefore, when the acceleration in the Z-axis direction is generated, the acceleration sensor 1 can detect a change in electrostatic capacitance between the movable electrode 21 and the fixed electrode 30 and calculate the acceleration in the Z-axis direction, without being affected by the external force or heat.

The first substrate 11 and the second substrate 12 are made of silicon. Therefore, the first substrate cavity 13, the second substrate cavity 14, the first anchor 17, the second anchor 29, the spring 18, the movable electrode 21, and the fixed electrode 30 are formed by etching the first substrate 11 and the second substrate 12 without performing a special process.

### Other Embodiments

The present disclosure can be modified in various ways without being limited to the configuration of the above-described embodiment.

In the above-described embodiment, the first substrate 11 is arranged on the —Z direction side and the second substrate 12 is arranged on the +Z direction side, but the first substrate 11 and the second substrate 12 may be arranged in reverse.

In addition, in the above-described embodiment, the first movable electrode 22 is separated into the first movable electrode first portion 22a and the first movable electrode second portion 22b, the second movable electrode 23 is separated into the second movable electrode first portion 23a and the second movable electrode second portion 23b, and the first movable electrode 22 and the second movable electrode 23 are mechanically connected to and electrically insulated from the first main frame 19a, the second main frame 19b, the first sub-frame 20a, the second sub-frame 20b, the first mass 24a, the second mass 24b, the first reinforcing frame 25a, and the second reinforcing frame 25b by the isolation joints 26. However, for example, the entire circumferences of the first movable electrode and the second movable electrode may be mechanically connected to the substrate and electrically insulated by being surrounded by the isolation joints.

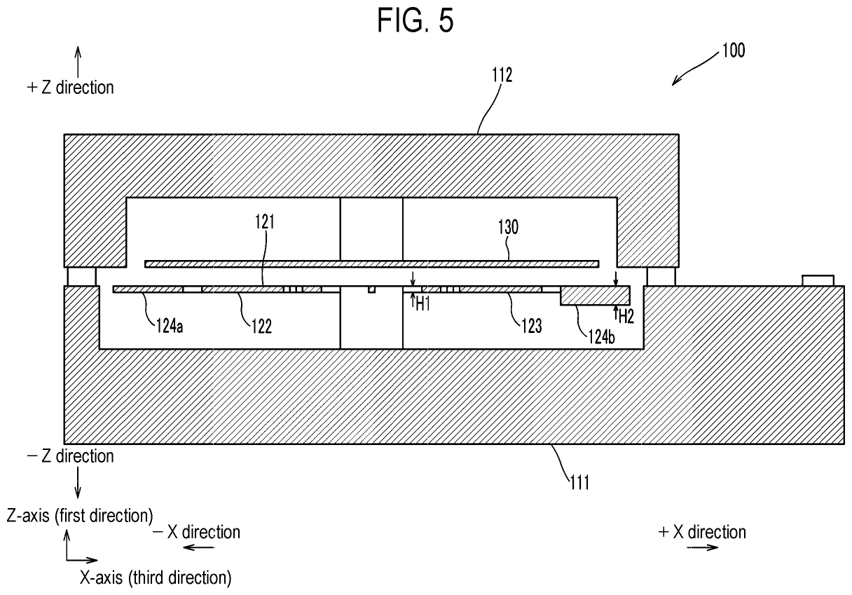

FIG. 5 is a partially-enlarged view of an acceleration sensor 100 according to another embodiment, particularly showing a second mass 124b facing a fixed electrode 130 of a second substrate 112. When viewed from the +Z direction, the second mass 124b has the same surface area as a first mass 124a. On the other hand, the second mass 124b has a second height H2 in the Z-axis direction that is larger than a first height H1 of the first mass 124a, a main frame, a sub-frame, a first movable electrode 122, and a second movable electrode 123 in the Z-axis direction. Thus, the second mass 124b has a larger mass than the first mass 124a. Therefore, when acceleration in the Z-axis direction is generated, since a difference in displacement in the Z-axis direction is generated due to inertia between the first movable electrode 122 and the second movable electrode 123, a movable electrode 121 tilts to either side of the Z-axis direction. Accordingly, the acceleration sensor 100 can determine a direction of the acceleration from the tilt of the movable electrode when the acceleration in the Z-axis direction is generated.

A first aspect of the present disclosure provides an acceleration sensor including:
a first substrate having a first substrate first main surface and a first substrate second main surface facing each other in a first direction; and
a second substrate having a second substrate first main surface and a second substrate second main surface facing each other in the first direction, the second substrate first main surface facing the first substrate first main surface in the first direction,
wherein the first substrate includes:
   a first substrate cavity recessed from the first substrate first main surface toward the first substrate second main surface;
   a first anchor region provided on a partial region of a bottom surface of the first substrate cavity;
   a first anchor protruding from the first anchor region toward the second substrate first main surface along the first direction;
   a spring extending from the first anchor in a second direction perpendicular to the first direction; and
   a movable electrode mechanically connected to and electrically insulated from the spring, and configured to be displaced in the first direction, and
wherein the second substrate includes:
   a second substrate cavity recessed from the second substrate first main surface toward the second substrate second main surface;
   a second anchor region provided on a partial region of a bottom surface of the second substrate cavity;
   a second anchor protruding from the second anchor region toward the first substrate first main surface along the first direction; and
   a fixed electrode mechanically fixed to the second anchor and facing the movable electrode.

A second aspect of the present disclosure provides the acceleration sensor of the first aspect, wherein the first substrate includes a base substrate, and
wherein the second substrate includes a lid substrate that seals the first substrate cavity and the second substrate cavity together with the base substrate.

A third aspect of the present disclosure provides the acceleration sensor of the first or second aspect, wherein the fixed electrode has a size overlapping with the movable electrode when viewed from the first direction.

A fourth aspect of the present disclosure provides the acceleration sensor of any one of the first to third aspects, wherein the movable electrode includes:
a first movable electrode arranged on a first side in a third direction that is perpendicular to the first direction and the second direction; and
a second movable electrode arranged on a second side in the third direction.

A fifth aspect of the present disclosure provides the acceleration sensor of the fourth aspect, further including:
a first mass mechanically connected to and electrically insulated from the first movable electrode; and
a second mass mechanically connected to and electrically insulated from the second movable electrode and having a larger mass than the first mass.

A sixth aspect of the present disclosure provides the acceleration sensor of the fifth aspect, wherein when viewed from the first direction, the first mass has a first surface area, and the second mass has a second surface area larger than the first surface area.

A seventh aspect of the present disclosure provides the acceleration sensor of the fifth aspect, wherein in the first direction, the first mass has a first height, and the second mass has a second height larger than the first height.

An eighth aspect of the present disclosure provides the acceleration sensor of any one of the fifth to seventh aspects, further including a main frame that extends from the spring in both sides of the third direction and is mechanically connected to and electrically insulated from the first movable electrode and the second movable electrode.

A ninth aspect of the present disclosure provides the acceleration sensor of the eighth aspect, wherein the spring includes;
a first spring extending in a first side of the second direction; and
a second spring extending in a second side of the second direction,
wherein the main frame includes:
a first main frame mechanically connected to the first spring, and mechanically connected to and electrically insulated from the first movable electrode and the second movable electrode; and
a second main frame mechanically connected to the second spring, and mechanically connected to and electrically insulated from the first movable electrode and the second movable electrode.

A tenth aspect of the present disclosure provides the acceleration sensor of the ninth aspect, further including:
a first sub-frame extending in the second direction to mechanically connect a first end of the first main frame and a first end of the second main frame to each other; and
a second sub-frame extending in the second direction to mechanically connect a second end of the first main frame and a second end of the second main frame to each other.

An eleventh aspect of the present disclosure provides the acceleration sensor of the tenth aspect,
wherein the first movable electrode includes:
   a first movable electrode first portion arranged on the first side in the second direction, and mechanically connected to and electrically insulated from the first main frame and the first sub-frame; and
   a first movable electrode second portion spaced apart from the first movable electrode first portion and arranged on the second side in the second direction, and mechanically connected to and electrically insulated from the second main frame and the first sub-frame, and
wherein the second movable electrode includes:
   a second movable electrode first portion arranged on the first side in the second direction, and mechanically connected to and electrically insulated from the first main frame and the second sub-frame; and
   a second movable electrode second portion spaced apart from the second movable electrode first portion and arranged on the second side in the second direction, and mechanically connected to and electrically insulated from the second main frame and the second sub-frame.

A twelfth aspect of the present disclosure provides the acceleration sensor of the eleventh aspect, further including:
a first reinforcing frame arranged between the first movable electrode first portion and the first movable electrode second portion, and extending from the first sub-frame toward the first mass along the third direction and mechanically connected to the first mass; and
a second reinforcing frame arranged between the second movable electrode first portion and the second movable electrode second portion, and extending from the second sub-frame toward the second mass along the third direction and mechanically connected to the second mass.

A thirteenth aspect of the present disclosure provides the acceleration sensor of the twelfth aspect, further including isolation joints that mechanically connect and electrically insulate between the first movable electrode first portion and the first main frame, between the first movable electrode first portion and the first sub-frame, between the first movable electrode first portion and the first mass, between the first movable electrode first portion and the first reinforcing frame, between the first movable electrode second portion and the second main frame, between the first movable electrode second portion and the first sub-frame, between the first movable electrode second portion and the first mass, between the first movable electrode second portion and the first reinforcing frame, between the second movable electrode first portion and the first main frame, between the second movable electrode first portion and the second sub-frame, between the second movable electrode first portion and the second mass, between the second movable electrode first portion and the second reinforcing frame, between the second movable electrode second portion and the second main frame, between the second movable electrode second portion and the second sub-frame, between the second movable electrode second portion and the second mass, and between the second movable electrode second portion and the second reinforcing frame, respectively.

A fourteenth aspect of the present disclosure provides the acceleration sensor of any one of the fourth to thirteenth aspects, wherein each of the first anchor region and the second anchor region has a length of 10 μm or more and 40 μm or less in the second direction and the third direction.

A fifteenth aspect of the present disclosure provides the acceleration sensor of any one of the first to fourteenth aspects, wherein the first substrate and the second substrate are made of silicon.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An acceleration sensor comprising:
a first substrate having a first substrate first main surface and a first substrate second main surface facing each other in a first direction; and
a second substrate having a second substrate first main surface and a second substrate second main surface facing each other in the first direction, the second substrate first main surface facing the first substrate first main surface in the first direction,
wherein the first substrate includes:
a first substrate cavity recessed from the first substrate first main surface toward the first substrate second main surface;
a first anchor region provided on a partial region of a bottom surface of the first substrate cavity;
a first anchor protruding from the first anchor region toward the second substrate first main surface along the first direction;
a spring extending from the first anchor in a second direction perpendicular to the first direction; and
a movable electrode mechanically connected to and electrically insulated from the spring, and configured to be displaced in the first direction, and
wherein the second substrate includes:
a second substrate cavity recessed from the second substrate first main surface toward the second substrate second main surface;
a second anchor region provided on a partial region of a bottom surface of the second substrate cavity;
a second anchor protruding from the second anchor region toward the first substrate first main surface along the first direction; and
a fixed electrode mechanically fixed to the second anchor and facing the movable electrode.

2. The acceleration sensor of claim 1, wherein the first substrate includes a base substrate, and
wherein the second substrate includes a lid substrate that seals the first substrate cavity and the second substrate cavity together with the base substrate.

3. The acceleration sensor of claim 1, wherein the fixed electrode has a size overlapping with the movable electrode when viewed from the first direction.

4. The acceleration sensor of claim 1, wherein the movable electrode includes:
a first movable electrode arranged on a first side in a third direction that is perpendicular to the first direction and the second direction; and
a second movable electrode arranged on a second side in the third direction.

5. The acceleration sensor of claim 4, further comprising:
a first mass mechanically connected to and electrically insulated from the first movable electrode; and
a second mass mechanically connected to and electrically insulated from the second movable electrode, and having a larger mass than the first mass.

6. The acceleration sensor of claim 5, wherein when viewed from the first direction, the first mass has a first surface area, and the second mass has a second surface area larger than the first surface area.

7. The acceleration sensor of claim 5, wherein in the first direction, the first mass has a first height, and the second mass has a second height larger than the first height.

8. The acceleration sensor of claim 5, further comprising a main frame that extends from the spring in both sides of the third direction and is mechanically connected to and electrically insulated from the first movable electrode and the second movable electrode.

9. The acceleration sensor of claim 8, wherein the spring includes;
a first spring extending in a first side of the second direction; and
a second spring extending in a second side of the second direction,
wherein the main frame includes:
a first main frame mechanically connected to the first spring, and mechanically connected to and electrically insulated from the first movable electrode and the second movable electrode; and
a second main frame mechanically connected to the second spring, and mechanically connected to and electrically insulated from the first movable electrode and the second movable electrode.

10. The acceleration sensor of claim 9, further comprising:
a first sub-frame extending in the second direction to mechanically connect a first end of the first main frame and a first end of the second main frame to each other; and
a second sub-frame extending in the second direction to mechanically connect a second end of the first main frame and a second end of the second main frame to each other.

11. The acceleration sensor of claim 10,
wherein the first movable electrode includes:
a first movable electrode first portion arranged on the first side in the second direction, and mechanically connected to and electrically insulated from the first main frame and the first sub-frame; and
a first movable electrode second portion spaced apart from the first movable electrode first portion and arranged on the second side in the second direction, and mechanically connected to and electrically insulated from the second main frame and the first sub-frame, and
wherein the second movable electrode includes:
a second movable electrode first portion arranged on the first side in the second direction, and mechanically connected to and electrically insulated from the first main frame and the second sub-frame; and
a second movable electrode second portion spaced apart from the second movable electrode first portion and arranged on the second side in the second direction, and mechanically connected to and electrically insulated from the second main frame and the second sub-frame.

12. The acceleration sensor of claim 11, further comprising:
a first reinforcing frame arranged between the first movable electrode first portion and the first movable electrode second portion, and extending from the first sub-frame toward the first mass along the third direction and mechanically connected to the first mass; and
a second reinforcing frame arranged between the second movable electrode first portion and the second movable electrode second portion, and extending from the second sub-frame toward the second mass along the third direction and mechanically connected to the second mass.

13. The acceleration sensor of claim 12, further comprising isolation joints that mechanically connect and electrically insulate between the first movable electrode first portion and the first main frame, between the first movable electrode first portion and the first sub-frame, between the first movable electrode first portion and the first mass, between the first movable electrode first portion and the first reinforcing frame, between the first movable electrode second portion and the second main frame, between the first movable electrode second portion and the first sub-frame, between the first movable electrode second portion and the first mass, between the first movable electrode second portion and the first reinforcing frame, between the second movable electrode first portion and the first main frame, between the second movable electrode first portion and the second sub-frame, between the second movable electrode first portion and the second mass, between the second movable electrode first portion and the second reinforcing frame, between the second movable electrode second portion and the second main frame, between the second movable electrode second portion and the second sub-frame, between the second movable electrode second portion and the second mass, and between the second movable electrode second portion and the second reinforcing frame, respectively.

14. The acceleration sensor of claim 4, wherein each of the first anchor region and the second anchor region has a length of 10 μm or more and 40 μm or less in the second direction and the third direction.

15. The acceleration sensor of claim 1, wherein the first substrate and the second substrate are made of silicon.
